(19) United States
(12) Patent Application Publication
(10) Pub. No.: US 2026/0284720 A1
(43) Pub. Date: Sep. 24, 2026

(54) PIPE CLEANING NOZZLE

(71) Applicant: OSIN Pipe Coating Inc., Toronto (CA)

(72) Inventors: Mohammad Shahvaziyan, YAZD (IR); Seyedarash Jafarianshahri, MASHHAD (IR); Noosh Afarin Papi Ghalavand, Tehran (IR); Muhamad Naqizade, SARI (IR); Eiman Aghababaei, Isfahan (IR); Nasser ASHGRIZ, Thornhill (CA)

(73) Assignee: OSIN Pipe Coating Inc., Toronto (CA)

(21) Appl. No.: 19/086,212

(22) Filed: Mar. 21, 2025

(51) Int. Cl. B08B 9/032; B05B 1/02

(52) U.S. Cl. CPC B08B 9/0321; B05B 1/02

(57) ABSTRACT

A hydrodynamic nozzle that can clean the interior of small diameter pipes is disclosed. The nozzle has a movable head that can turn with respect to the nozzle base. The nozzle has two sets of fluid ejection orifices. A set of propelling orifices and set of guiding orifices. The set of guiding orifices only open when the nozzle head bends, therefor, they propel the nozzle in the direction of the bent. The fluid that is turned backwards results in a trust that propels the nozzle forward. Another part of the fluid enters into the front part of the nozzle to provide front cleaning of the internal parts of a pipe.

### TECHNICAL FIELD OF THE INVENTION

The present invention in general relates to a nozzle for cleaning pipes and ducts, and in particular to a nozzle that can easily turn in pipe pends.

### BACKGROUND

Water pipe repair has become of great importance because of the aging piping infrastructure and increase in water wastage by leaking water lines. In addition, aging water lines have resulted in water contamination and loss of water quality. Water leakage from pipes is not only financially costly but also a significant loss to an essential human resource. As the water infrastructures age, defects, such as leakage, cracks, wears, blockages, etc., result in water loss in the system.

Both traditional pipe replacement and trenchless methods are used to repair damaged pipes. Trenchless pipe repair is preferred since it does not involve any digging and damage to the property. However, the trenchless method may cost more than pipe replacement because of the time it takes to push a nozzle through the piping system and repeated coating, both of which depend on the operator doing the job.

Trenchless pipe repair comprises inserting a nozzle inside the pipe to clean and coat the pipe from the inside. Trenchless pipe repair and restoration for small size pipes (less than 6″) is a challenging task since it is difficult to insert a fully automated and robotic coating system inside the pipe as is done in larger pipes. In this process, first, a camera is inserted into the piping system to identify the problem areas, and then a cleaning nozzle is inserted into the piping system and it is moved through multiple bends, traveling two or three floors and carrying a long and heavy hose with it. An operator controls the movement of the nozzle. This process is time-consuming and requires operator skill to properly maneuver the nozzle through the piping system.

We have developed a nozzle that can easily move through complex piping system and turn in pipe bends without any need for operator expertise.

### SUMMARY OF THE INVENTION

The present invention is a hydrodynamic nozzle with a moving head. It comprises of a nozzle base and moving nozzle head. The nozzle base has a bottom surface, a top surface and a central axis. Fluid (water, steam, air, etc.) enters from an opening at its bottom surface. Part of the fluid goes straight through leave from an opening on its top surface. The nozzle base also has a set of internal base channels that turn a fraction of the inlet fluid flow by a set angle with respect to the central axis of the nozzle. Then this fraction of the fluid is guided to exit the nozzle base from a set of outlet nozzles on the bottom surface of the nozzle base. These form a set of propulsion jets that propel the hydrodynamic nozzle in a forward moving direction along the central axis.

The nozzle head of the present hydrodynamic nozzle has a nozzle-head-bottom surface and a nozzle-head-top surface, wherein fluid enters through the nozzle-head-bottom surface and exits from a top orifice at the nozzle-head-top surface.

The nozzle has a ball and socket mechanism that flexibly connects the nozzle head to the nozzle base. This mechanism comprises of a socket element that has a set of internal head channels that take fluid from a set of socket orifices to issue fluid from a set of guide orifices on a periphery of the socket element. The set of guide orifices have an angle with respect to the central axis. The mechanism also has a ball element that has a ball central channel with a ball inlet and a ball outlet. The ball inlet is flared. The ball element is placed on the socket element and configured that when the ball element tilts inside the socket element, at least one of the socket orifices is exposed to fluid, and thereby, at least a guiding fluid jet issues from at least a guide orifice that is in an opposite direction of the ball element tilt. The guiding fluid jets propel the hydrodynamic nozzle in the tilt direction of the head or the ball.

A clamp mechanism holds the nozzle head on the nozzle base, while allowing the nozzle head to move. This nozzle is configured such that the inlet fluid flow is divided into three different parts. A first part exiting from the bottom surface of the nozzle base to propel the hydrodynamic nozzle forward. A second part exiting from the top orifice of the nozzle head to clean or coat interiors of pipes and ducts. A third part exiting from the set of guide orifices to propel the nozzle in bends and turns in piping or ducting systems.

In another embodiment of the present hydrodynamic nozzle the system, the nozzle head is amalgamated into the ball element of the ball socket mechanism. This embodiment comprises of a tubular nozzle cover that has a tube wall and a bottom lip at its open bottom and a set of side orifices on the tube wall. In this embodiment, a nozzle base that has an extension on its top surface is placed inside the tubular nozzle cover and on its bottom lip. Flow enters the nozzle based through its nozzle-base-bottom inlet and goes through it towards its nozzle-base-top outlet. It also has a set of internal base channels that turn a first fraction of the inlet fluid flow by a first angle with respect to the central axis and guide it to exit the nozzle base from a set of first outlet nozzles on a bottom surface of the nozzle base forming a set of propulsion jets to propel the hydrodynamic nozzle in a forward moving direction along the central axis. Sealing O-rings are placed in between the tubular nozzle cover and the nozzle base.

In this embodiment, a first socket element, which has a set of internal guide channels that are configured to carry fluid towards the set of side orifices on the tube wall, is placed on the base top surface. A nozzle head having a ball bottom element and a ball axial opening, is configured to sit in the first socket element. The ball axial opening is flared at the ball bottom element. A a spring is placed inside the ball axial opening that is squeezed between the nozzle head and the first socket element. A clamping mechanism clamps down on the nozzle head and locks the nozzle head inside the tubular nozzle cover. In this embodiment, when the nozzle head tilts, the ball element tilts inside the first socket element exposing at least one side orifice on the tubular nozzle cover to fluid. Thereby fluid issues from the at least one side orifice, propelling the hydrodynamic nozzle in the tilt direction.

None of the current nozzles are designed for easy turn in a pipe bend or a tee joint. The operator has to control the movement of the nozzle. Our nozzle is made of two sections. The rear section has a rear jet to propel the nozzle forward. Whereas the front section, which is flexibly attached to the rear section has side jets that turn on when the nozzle reaches a bend, to change the direction of the nozzle.

The objectives of the present invention are to provide a hydrodynamic nozzle having improved cleaning capacity, better and easier maneuverability in piping and ducting systems, reduced consumption of water and correspondingly reduced power consumption.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 is a perspective view of a first embodiment of a hydrodynamic nozzle according to the present invention;

FIG. 2A is an exploded cross sectional view of the first embodiment of the present invention;

FIG. 2B is an exploded 3D view of the first embodiment of the present invention;

FIG. 2C is a rendered exploded cross sectional view of the first embodiment of the present invention;

FIG. 3 shows the nozzle attachment to a hose;

FIG. 4A shows the fluid flow path inside the nozzle when nozzle tip is un-tilted;

FIG. 4B shows the fluid flow path inside the nozzle when the nozzle is tilted;

FIG. 5 is an exploded cross sectional view of the second embodiment of the present invention;

FIG. 6A shows the fluid flow path inside the nozzle when nozzle tip is untilted;

FIG. 6B shows the fluid flow path inside the nozzle when the nozzle is tilted;

FIG. 7A shows the nozzle reaching to a pipe bend;

FIG. 7B shows the nozzle turning into the pipe bend as nozzle tip tilts and the size jet propel the nozzle into the pipe bend, and

FIG. 7C shows the progress of the nozzle into the pipe after the pipe bend.

### DETAILED DESCRIPTION OF THE INVENTION

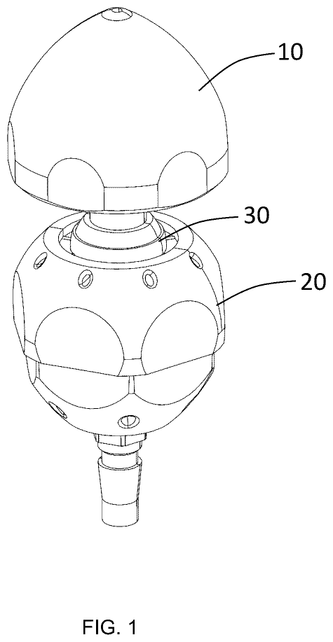

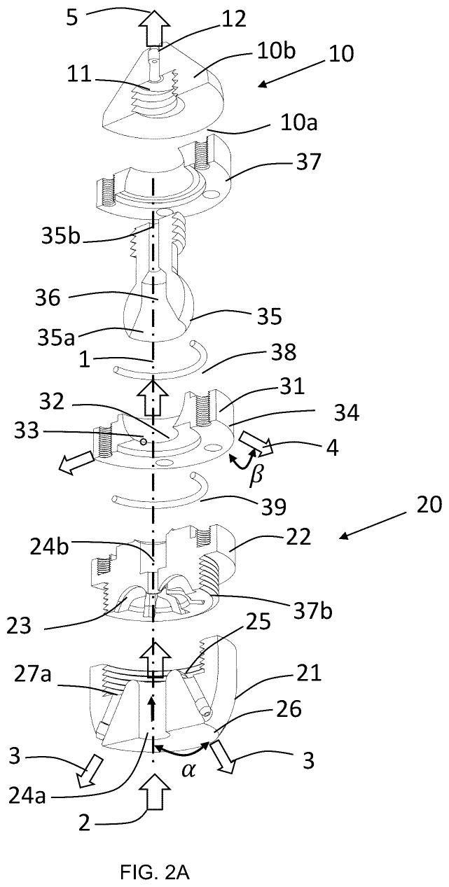

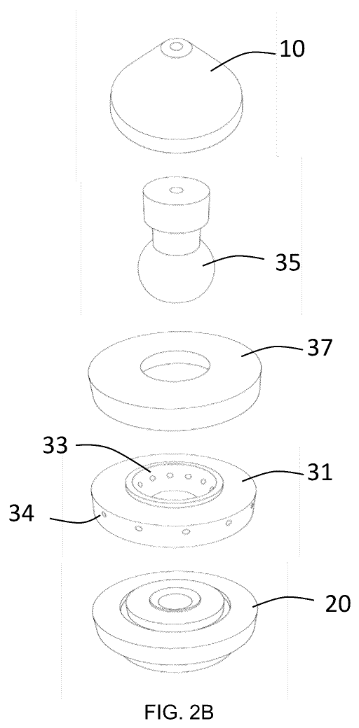

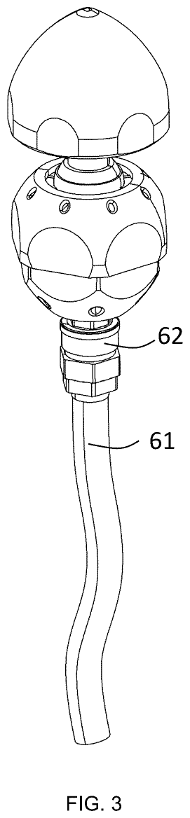

FIG. 1 shows a perspective view of the first embodiment of the present nozzle, and FIG. 2A-B and FIG. 3 show its different parts of the nozzle. A hydrodynamic nozzle is provided that comprises a nozzle head (10) and nozzle base (20) and a connecting mechanism (30) movably connecting the nozzle head (2) to the nozzle base (30).

The nozzle base (20) has a bottom section (21), a top section (22) and a central axis (1). An inlet fluid flow (2) enters the nozzle from a fluid inlet (24a) at the bottom section (21) of the nozzle base and leaves from a base fluid outlet (24b) at the top section (22). The nozzle base has a set of internal base channels (23) that turn part of the inlet fluid flow (2) by an angle (α) with respect to the central axis (1) and guide it to exit the nozzle base from a set of outlet nozzles (26) on the bottom section (21) of the nozzle base. These form a set of propulsion jets (3) to propel the hydrodynamic nozzle in a forward moving direction. The nozzle base can be manufactured in two parts (21, 22) with the channels (23) built one part and the two parts are screwed together (27a, 27b). Or it can be made of one piece with other manufacturing processes such as molding, 3D printing or drilling process.

The nozzle head (10) has a nozzle-head-bottom surface (10a), a nozzle-head-top surface (10b), and a central opening (11). The nozzle head can be conical or other shapes, depending on the purpose of the nozzle. Generally conical shapes are used for ease of forward movement in ducts and pipes. Fluid enters through the nozzle-head-bottom surface and exits from a top orifice (12) at the nozzle-head-top surface (10b). The top orifice (12) is configured to receive any variety of nozzle tips, such a spray tip.

A ball and socket mechanism (30) is used to flexibly connect the nozzle head to the nozzle base. This mechanism comprises of a socket element (31) and ball element (35). The socket element (31) has a socket top surface (32), and a set of socket orifices (33) on the socket top surface (32) to guide fluid to a set of guide orifices (34) on a periphery of the socket element each having a second angle (β) with respect to the central axis (1).

The ball element (35) has a ball central channel (36) having a ball inlet (35a) and a ball outlet (35b). The ball inlet of the ball central channel is flared. The ball element is placed on the socket element and configured that when the ball element tilts inside the socket element, at least one of the socket orifices (33) is exposed to fluid. In this situation, at least one guiding fluid jet (4) issues from at least one guide orifice (34) that is in an opposite direction of the ball element tilt. This propels the hydrodynamic nozzle in a ball element tilt direction. In one embodiment, the ball element is screwed into the nozzle head, however, other connecting mechanisms cab also be used.

A clamp mechanism (37) is provided to hold the nozzle head on the nozzle base, while allowing the nozzle head to move. In this embodiment, the inlet fluid flow (2) is divided into three different parts. A first part (3) exiting from the bottom surface of the nozzle base to propel the hydrodynamic nozzle forward. A second part (5) exiting from the top orifice of the nozzle head to clean or coat interiors of pipes and ducts. A third part (4) exiting from the set of guide orifices to propel the nozzle in bends and turns in piping or ducting systems.

The nozzle head 10 is preferably rotationally symmetric, however, any shape is feasible. The nozzle head and nozzle base are preferably made of a metal, however, they can generally be made of any resilient material. The nozzle head, and in particular, the ball joint is preferably made of a low friction material. Since the pressure inside the nozzle may be high, a low friction material is preferred to allow the ball joint to easily rotate inside the nozzle. Materials such as phosphor-bronze or cast iron can be used for this purpose. Fluid enters the nozzle base 20 from inlet 24 at high pressure. The nozzle can be designed to handle a wide range of pressures, preferably 3000-300,000 kPa.

The fluid entering the nozzle at 24 is then divided into several different channels. Part of the fluid is turned through a number of turning channels 23 on the second part 22 of the base 20 and enters into a number of orifices 25 on the first part 21 of the base 20. The fluid entering the nozzles 25 exits the base through a set of propelling orifices 26. The propelling orifices 26 eject the fluid in the opposite direction of the inlet flow, therefore, based on the physics of reaction, a thrust is formed that moves the nozzle forward. The high velocity fluid discharging from exit orifices 26 results that the nozzle propels forward. There can be any number of propelling orifices, the number depends on the size of the nozzle. The orifice diameters also vary depending on the fluid flow rate and pressures that are used.

The fluid channels are recesses 23 that move the intake fluid 24 to the exit fluid 26. The liquid that exits the nozzle has enough pressure that not only propels the nozzle forward, but also it can clean the nozzle. The angle α of the exit orifices with respect to the nozzle central axis 1 can be in a range of 0 to 80 degrees. The nozzles may also have a tangential component (not shown) to control the rotation of the nozzle.

Another part of the fluid goes through the ball 31 and stem 32 and enters the nozzle head 10. The nozzle head has a channel 11 and orifice 12 that issues the fluid in the forward direction. Any type of spraying nozzles can be installed in the orifice 12. The type of the spraying nozzle depends on the type of fluid dispersion and cleaning that is needed in the front side of the nozzle.

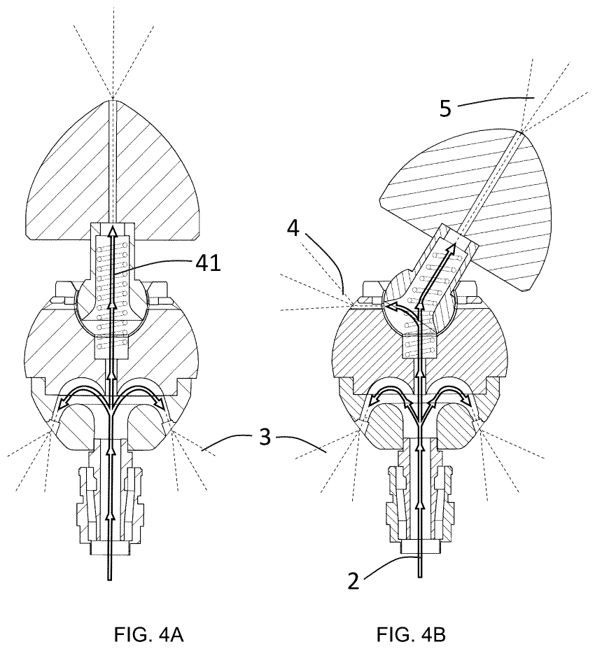

The inlet orifice 24 may have a connection means to connect to a fluid supply line as shown in FIG. 3. The nozzle head may have a spring 41 as shown in FIG. 4A, such as a cylindrical tension spring, to keep the nozzle head stable. Gasket 38, 39 are used to keep the ball and socket joint sealed. As the nozzle is propelled inside a pipe or a duct, it forces the fluid on the interior of the pipe or duct, which results in cleaning them.

A second set of guiding orifices are provided in the second part of the base. These guiding orifices 36 are provided to guide the nozzle in the direction of turn. The nozzles are better shown in FIG. 2C. The ball 31 is configured to block the guiding orifices 36 when the nozzle head is along the axis 1 of the nozzle. However, as the nozzle head turns, the ball is turned and it uncovers the orifices that are in the opposite direction of the turn. This allows high pressure fluid exits the guiding nozzles, and therefore propels the nozzle in that direction.

As described, when a high pressure fluid is pumped into a hose 61, the fluid flows into the nozzle at the connection 62. Some of the fluid ejected out of the nozzle through propelling orifices 26 and some from the front orifice 12 to clean an interior of a pipe. When the nozzle head turns, the guiding orifices open, and some of the fluid is injected out of the guiding orifices 36, helping the nozzle to turn in the opposite direction of the flow.

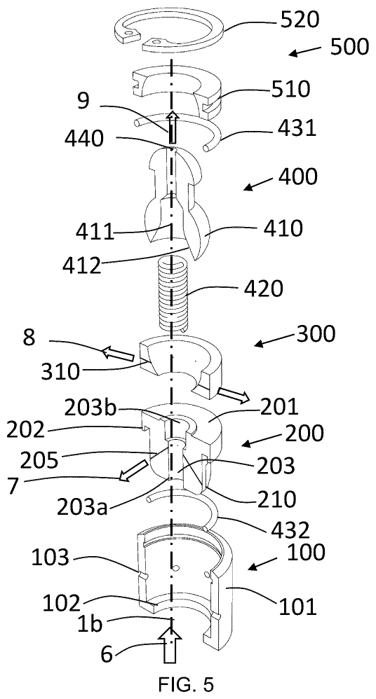

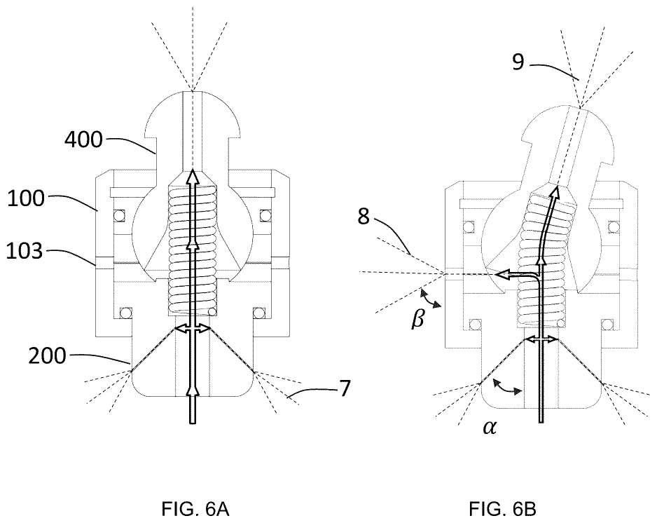

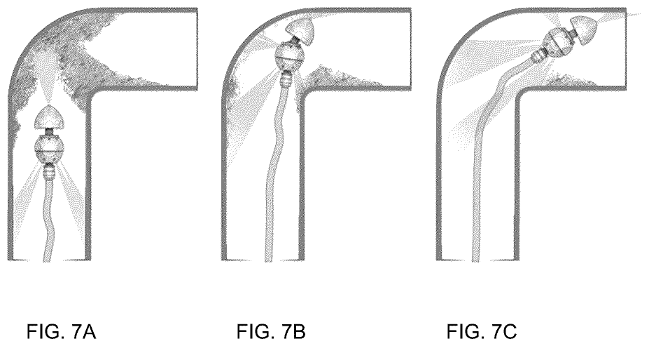

A second embodiment of the present pipe cleaning nozzle is provided in FIG. 5 with its operation in FIGS. 6A and 6B. The nozzle comprises of a tubular nozzle cover (100) having a central axis (1b) and having a tube wall (101). The tubular nozzle cover has a bottom lip (102) at its open bottom. It also has a set of side orifices (103) on the tube wall (101). Different parts of the nozzle are placed inside the tubular nozzle cover and are locked in it. First a nozzle base (200) is placed inside the cover. The nozzle base (200) has a base top surface (201) with a base top extension (202). The nozzle base has a base central opening (203) to receive an inlet fluid flow (6) from a nozzle-base-bottom inlet (203a) and allow fluid flow out from a nozzle-base-top outlet (203b). A set of internal base channels (205) are configured to turn a first fraction of the inlet fluid flow by an angle α with respect to the central axis (1b) and guide it to exit the nozzle base from a set of first outlet nozzles (210) on a bottom surface of the nozzle base. These form a set of propulsion jets (7) to propel the hydrodynamic nozzle in a forward moving direction. The top extension (202) of the nozzle base is configured to be sealably placed on the bottom lip of the nozzle cover. In one embodiment an O-ring 432 is used to seal the two parts. Next a socket element (300) is placed inside the tubular cover and on the top of the base (201). The socket element (300) has a set of socket orifices (310) that are configured to carry fluid towards the set of side orifices (103) on the tube wall.

Then a nozzle head (400) that has a ball bottom element (410) and a ball axial opening (411) is placed on the socket element (300). The ball axial opening (411) is flared (412) at the ball bottom element. A spring (420) is placed inside the ball axial opening (411) that will be squeezed between the nozzle head and the first socket element once the nozzle is locked by a clamping mechanism. The clamping mechanism (500), which comprises of a socket part (510) to sit on top of the ball element (410), and a locking ring (520) to lock into the tubular cover 100, is used to clamp down on the nozzle head and lock the nozzle head inside the tubular nozzle cover. A set of O-rings (431, 432) are used to seal the joints at different parts of the nozzle.

In this embodiment, when the nozzle head tilts, the ball element tilts inside the first socket element exposing at least one side orifice on the tubular nozzle cover to fluid. Then the fluid issues from the at least one side orifice, propelling the hydrodynamic nozzle in the tilt direction. The angle β of the exit orifices with respect to the nozzle central axis can be in a range of 15-70 degrees preferably 45 degrees.

While the invention has been illustrated and described as embodied in the context of a hydrodynamic nozzle for cleaning pipes and channels, it is not intended to be limited to the details shown, since various modifications and structural changes may be made without departing in any way from the spirit of the present invention.

1. A hydrodynamic nozzle, comprising:
a) a nozzle base having a bottom section and a top section and having a central axis, and having a fluid inlet at the bottom section to allow an inlet fluid flow into the nozzle base and out of a base fluid outlet at the top section, both along the central axis, and further having a set of internal base channels that turn a first fraction of the inlet fluid flow by a first angle (α) with respect to the central axis and guide it to exit the nozzle base from a set of first outlet nozzles on the bottom section of the nozzle base forming a set of propulsion jets to propel the hydrodynamic nozzle in a forward moving direction along the central axis;
b) a nozzle head having a nozzle-head-bottom surface and a nozzle-head-top surface, wherein fluid enters through the nozzle-head-bottom surface and exits from a top orifice at the nozzle-head-top surface;
c) a ball and socket mechanism flexibly connecting the nozzle head to the nozzle base, comprising:
i) a socket element having a socket top surface, and having a set of socket orifices on the socket top surface to guide fluid to a set of guide orifices on a periphery of the socket element each having a second angle (β) with respect to the central axis, and
ii) a ball element having a ball central channel having a ball inlet and a ball outlet, wherein the ball inlet of the ball central channel is flared, and wherein the ball element is placed on the socket element and configured that when the ball element tilts inside the socket element, at least one of the socket orifices is exposed to fluid, and thereby, at least one guiding fluid jet issues from at least one guide orifice that is in an opposite direction of the ball element tilt, thereby propelling the hydrodynamic nozzle in a ball element tilt direction, and
d) a clamp mechanism to hold the nozzle head on the nozzle base, while allowing the nozzle head to move,
whereby the inlet fluid flow is divided into three different parts, with a first part exiting from the bottom surface of the nozzle base to propel the hydrodynamic nozzle forward, a second part exiting from the top orifice of the nozzle head to clean or coat interiors of pipes and ducts, and a third part exiting from the set of guide orifices to propel the nozzle in bends and turns in piping or ducting systems.

2. The hydrodynamic nozzle of claim 1, further having a spring placed around the ball and socket mechanism to force back the nozzle head towards the central axis when it is bent.

3. The hydrodynamic nozzle of claim 1, wherein the first angle of each of propulsion jets is in the range 0 to 80 degrees with respect to the nozzle axis.

4. The hydrodynamic nozzle of claim 1, wherein the second angle of each of propulsion jets is in the range 60 to 90 degrees with respect to the nozzle axis.

5. The hydrodynamic nozzle of claim 1, wherein the nozzle head and the nozzle base are rotationally symmetric.

6. The hydrodynamic nozzle of claim 1, wherein the nozzle head and nozzle base are made of a metal, phosphor-bronze or cast iron.

7. The hydrodynamic nozzle of claim 1, wherein the ball and socket mechanism is configured to operate at pressures in the range of 3000 to 300,000 kPa.

8. The hydrodynamic nozzle of claim 1, further having a set of tangential nozzles on the nozzle base to control the rotation of the hydrodynamic nozzle.

9. The hydrodynamic nozzle of claim 1, wherein the top orifice of the nozzle head is configured to receive a spray nozzle for cleaning or coating purposed.

10. The hydrodynamic nozzle of claim 1, wherein an opening diameter of the base fluid outlet at the top surface of the nozzle base is configured to restrict fluid flow though the base fluid outlet and force the first fraction towards the set of outlet nozzles.

11. A hydrodynamic nozzle, comprising:
a) a tubular nozzle cover having a central axis and having a tube wall and a bottom lip at its open bottom and a set of side orifices on the tube wall;
b) a nozzle base having a base top surface with a base top extension,
i) a base central opening to receive an inlet fluid flow from a nozzle-base-bottom inlet and allow fluid flow from a nozzle-base-top outlet,
ii) a set of internal base channels that turn a first fraction of the inlet fluid flow by a first angle with respect to the central axis and guide it to exit the nozzle base from a set of first outlet nozzles on a bottom surface of the nozzle base forming a set of propulsion jets to propel the hydrodynamic nozzle in a forward moving direction along the central axis, and
iii) wherein the top extension of the nozzle base is configured to be sealably placed on the bottom lip of the nozzle cover;
c) a first socket element having a socket orifice that are configured to carry fluid towards the set of side orifices on the tube wall, and wherein the first socket element is placed on the base top surface;
d) a nozzle head having a ball bottom element and a ball axial opening, wherein the ball bottom element is configured to sit in the first socket element, the ball axial opening is flared at the ball bottom element, and wherein a spring is placed inside the ball axial opening that is squeezed between the nozzle head and the first socket element, and
e) a clamping mechanism to clamp down on the nozzle head and lock the nozzle head inside the tubular nozzle cover,
whereby, when the nozzle head tilts, the ball element tilts inside the first socket element exposing at least one side orifice on the tubular nozzle cover to fluid, thereby fluid issues from the at least one side orifice, propelling the hydrodynamic nozzle in the tilt direction.
